(19) United States
(12) Patent Application Publication
(10) Pub. No.: US 2004/0032120 A1
(43) Pub. Date: Feb. 19, 2004

(54) Progressive steering system

(76) Inventors: Esa Vaisanen, Rovaniemi (FI); Alain Massicotte, Orford (CA); Bruno Girouard, Montreal (CA); Daniel Mercier, Longueuil (CA); Berthold Fecteau, Richmond (CA)

Correspondence Address: PILLSBURY WINTHROP, LLP, P.O. BOX 10500, MCLEAN, VA, 22102, US

(21) Appl. No.: 10/371,227

(22) Filed: Feb. 24, 2003

Related U.S. Application Data
(60) Provisional application No. 60/358,396, filed on Feb. 22, 2002.

(51) Int. Cl. B62D 1/00

(52) U.S. Cl. 280/771

(57) ABSTRACT

A vehicle has a progressive steering system that includes a variable-length moment arm, the length of which varies as a function of a steering angle of the steering system. As the steering system is pivoted away from a neutral position, the torque that must be applied to a steering actuator to pivot the steered device and a rate of steering movement of the steered device per degree or rotation of the steering actuator both increase. The variable-length moment arm is formed by offset pivoting swivel and guide arms. A ball bearing that is fixed to the guide arm engages a groove formed in the swivel arm. Consequently, the ball bearing defines a force acting point that is located a variable distance from the swivel arm's pivotal axis.

### CROSS-REFERENCE TO RELATED APPLICATION(S)

This application relies for priority on U.S. Provisional Patent Application Serial No. 60/358,396, entitled “PROGRESSIVE STEERING SYSTEM,” which was filed on Feb. 22, 2002, the contents of which are incorporated herein by reference.

This application is related but does not claim priority to the following U.S. provisional applications that were filed on Feb. 22, 2002: Nos. 60/358,362, 60/358,390, 60/358,400, 60/358,394; 60/358,395; 60/358,397; 60/358,398; 60/358,436; and, 60/358,439 and any non-provisional patent applications claiming priority to the same.

This application is also related but does not claim priority to U.S. provisional application No. 60/358,737, which was filed on Feb. 25, 2002, and U.S. provisional application No. 60/418,355, which was filed on Oct. 16, 2002, and any non-provisional patent applications claiming priority to the same. The entirety of the subject matter of these applications is incorporated by reference herein.

This application is also related to but does not claim priority to U.S. Design application Ser. No. 29/155,964 filed on Feb. 22, 2002, and U.S. Design application Ser. No. 29/156,028 filed on Feb. 23, 2002.

This application is also related to but does not claim priority to U.S. patent application Ser. No. 10/346,188 and U.S. patent application Ser. No. 10/346,189 which were filed on Jan. 17, 2003. The entirety of the subject matter of these applications is incorporated by reference herein.

### BACKGROUND OF THE INVENTION

1. Field of the Invention

The present invention relates to steering systems for vehicles. More specifically, the present invention relates to steering systems for vehicles including, but not limited to, recreational vehicles such as snowmobiles, all terrain vehicles (“ATVs”), and three-wheeled vehicles.

2. Description of Related Art

For steering, conventional tracked and wheeled vehicles such as snowmobiles and all-terrain vehicles (ATVs) are equipped with steering systems that allow a rider to selectively control the steering angle of a steerable device (i.e., ski(s) or wheel(s)) relative to a longitudinal direction of the vehicle.

FIG. 1 is a perspective exploded view of a conventional steering system for a snowmobile. For ease of explanation, only one half of the assembly is explained in detail. As would be understood by one of ordinary skill in the art, and as should be understood from the drawing, a description of the other side would be the same. The steering components and their interconnection are described below.

A handlebar 10 is connected to a steering shaft 12. The steering shaft 12 is mounted to a snowmobile frame for pivotal movement about a steering shaft axis 14 relative to the frame. A handlebar arm 16 extends radially outwardly from the steering shaft 12. A ball-end 20 defining a tie rod axis 22 that includes a force acting point is connected to the handlebar arm 16 such that the tie rod axis 22 is offset from the steering shaft axis 14 by a fixed distance H. A first handlebar tie rod eye-end 26, connected to one end of a handlebar tie rod 30, is pivotally connected to the ball-end 20 such that the handlebar tie rod 30 pivots relative to the handlebar arm 16 about the tie rod axis 22. A second handlebar tie rod eye-end 32 is connected to the other end of the handlebar tie rod 30.

A swivel arm 40 is operatively mounted to the frame of the vehicle (not shown) for pivotal movement relative to the frame about a swivel arm axis 42. A ball-end 44 having a second tie rod axis 46 that defines another force acting point is mounted to the swivel arm 40 such that the second tie rod axis 46 is offset from the swivel arm axis 42 by a fixed distance I. The ball-end 44 is connected to the second handlebar tie rod eye-end 32 such that the handlebar tie rod 30 pivots relative to the swivel arm 40 about the second tie rod axis 46.

A second swivel arm 48 is also mounted to the frame. A steering arm tie rod 50 is connected with a bolt to the swivel arm 40 for pivotal movement relative to the swivel arm 40 about a steering arm tie rod axis 52. The steering arm tie rod 50 is also connected to the frame by the second swivel arm 48. By this, the steering arm tie rod 50 remains laterally oriented relative to the frame while the swivel arms 40, 48 pivot. The steering arm tie rod axis 52 is offset from the swivel arm axis 42 by a predetermined fixed distance J. The steering arm tie rod 50 is a compound rod having a ball joint disposed therein that allows an outer portion 50a (i.e., laterally outward) of the steering arm tie rod 50 to pivot relative to an inner portion 50b. The outer portion 50a is connected to a steering arm tie rod eye-end 56. The steering arm tie rod eye-end 56 is connected to a steering arm ball-end 58 having a center axis 60.

The steering arm ball-end 58 is connected to a steering arm 62 such that the steering arm tie rod 50 pivots relative to the steering and 62 about the center axis 60. The steering arm 62 is operatively connected to the frame for pivotal movement relative to the frame about a steering arm axis 64 that is offset from the center axis 60 by a predetermined distance K. A ski (not shown in FIG. 1) is operatively connected to the steering arm 62 for common pivotal movement with the steering arm 62 about the steering arm axis 64 relative to the frame.

To steer the snowmobile, an operator pivots the handlebar 10. The rotation of the handlebar 10 is transferred into semi-circular movement of the handlebar tie rod 30 via a moment arm formed over the distance H on the handlebar arm 16. The semi-circular movement of the handlebar tie rod 30 is reconverted into pivotal movement of the swivel arm 40 via a moment arm formed over the distance I on the swivel arm 40. The pivotal movement of the swivel arm 40 is converted into semi-circular movement of the steering arm tie rod 50 via a moment arm formed over the distance J on the swivel arm 40. The semi-circular movement of the steering arm tie rod 50 is converted into pivotal movement of the steering arm 62 via a moment arm formed over the distance K on the steering arm 62. The ski pivots with the steering arm 60 to steer the snowmobile.

As would be appreciated by one skilled in the art, the relative lengths of the distances H, I, J, and K (and consequently the length of the moment arms) will determine the degree to which the ski will pivot as the handlebar 10 is rotated. Specifically, the longer the distances H and/or J are relative to the distances I and/or K, the greater the rotational movement of the ski will be per degree of rotation of the handlebar 10.

It is advantageous to provide a greater pivotal range for the ski in order to enable the snowmobile to make tighter turns and be more maneuverable. Assuming that the handlebar 10 has a limited pivotal range, the pivotal range of the ski can be improved by increasing the distances H and/or J relative to the distances I and/or K.

Unfortunately, increasing the pivotal range of the ski also increases the amount of torque that a snowmobile rider must exert on the handlebar 10 in order to pivot the ski. As would be appreciated by one skilled in the art, the moment arms formed over the distances H, I, J, and K will determine the amount of torque that the snowmobile rider must exert on the handlebar 10 in order to overcome a resistance of the ski to pivoting. Specifically, as the distances H or J increase relative to the distances I or K, the torque required to pivot the handlebar 10 also increases. As a result, the torque required to rotate handlebar 10 (and thus the ski) is inversely proportional to the pivotal range of the ski.

Numerous factors will affect the resistance of the ski to pivotal steering movement. For example, the weight and weight distribution of the snowmobile and the type of skis used will affect the resistance. In particular, more steering torque must be applied to aggressive skis, which are used in trail snowmobiles, than to mountain skis that are primarily used for their floatation characteristics.

In addition to decreasing the torque that must be applied to the handlebar 10 to steer the skis, increasing the distances H or J relative to the distances I or K has the added benefit of providing finer steering control over the skis. Because a larger pivotal range of the handlebar 10 corresponds to a smaller pivotal range of the skis, the snowmobile rider has better control over the precise steering position of the skis.

In conventional snowmobiles, a balance must be struck between increasing the pivotal/steering range of the skis to increase maneuverability and decreasing the torque that must be applied to the handlebar 10 in order to steer the skis.

This balance is not unique to snowmobiles. In fact, as would be appreciated by those skilled in the art, a similar balance is desirable for any vehicle that relies on a handlebar for steering including, for example, an ATV.

### SUMMARY OF THE INVENTION

One aspect of the present invention provides a versatile, inexpensive steering system for vehicles.

A further aspect of the present invention is to provide a progressive steering system especially designed for use with a handlebar steering device.

An additional aspect of the present invention provides a steering system that increases the steering range of the steered device without disadvantageously increasing the torque that must be applied to the steering actuator/handlebar when the steering system is at or near a neutral position (i.e., with the steered device pointing straight forward relative to the vehicle).

A further aspect of the present invention provides a progressive steering system in which the steered device pivots progressively more per degree of rotation of the steering actuator as the steering actuator and steered device pivot away from a neutral position.

A further aspect of the present invention provides a vehicle including a frame and a drive system supported by the frame. A swivel arm is connected to the frame for pivotal movement relative to the frame about a swivel arm axis. A first force acting point is located on the swivel arm a variable distance from the swivel arm axis. The variable distance varies as a function of an angle of the swivel arm relative to the frame about the swivel arm axis. A second force acting point is located on the swivel arm a first predetermined fixed distance from the swivel arm axis. A steered device is supported by the frame for pivotal movement relative to the frame about a steered device axis. The steered device is operatively connected to one of the force acting points. A steering actuator operatively connects to the other of the force acting points.

According to a further aspect of the present invention, the steered device is aligned with a forward direction of the vehicle when the swivel arm is disposed at a neutral angle. The other of the first and second force acting points is the first force acting point. The variable distance decreases as the swivel arm pivots away from the neutral angle toward an extreme steering angle. Alternatively, the one of the first and second force acting points may be the first force acting point with the variable distance increasing as the swivel arm pivots away from the neutral angle toward an extreme steering angle.

The first force acting point may be constrained to movement that is relative to the swivel arm along a line, which may intersect the swivel arm axis.

The vehicle may further include a guide arm operatively connected to the frame for pivotal movement relative to the frame about a guide arm axis that is offset from the swivel arm axis. The first force acting point is connected to the guide arm at a second predetermined fixed distance from the guide arm axis. The guide arm axis preferably intersects the line when the steered device is aligned with a forward direction of the vehicle. A groove formed in the swivel arm defines the line. A ball-end is attached to the guide arm. An axial centerline of the ball-end defines the first force acting point. Movement of the ball-end is constrained to movement along the line of the groove.

In the case of an ATV, which typically has two front and two rear wheels separated from one another, the powered wheel or wheels may be at the front or rear of the vehicle. In the case of an ATV with four-wheeled driving capabilities, all four of the wheels may be powered. Typically, the front wheels of the ATV are the steered wheels, although it is known to provide steering using all four wheels as well.

In the case of a snowmobile, the vehicle includes an endless track that is powered by the engine (or other suitable power source). The endless track propels the vehicle when driven by the engine. The ski or skis at the front of the snowmobile are used to steer the vehicle.

According to a further aspect of the present invention, the steered device includes at least one steered wheel. The drive system includes an engine operatively connected to a powered wheel. The powered wheel is disposed rearwardly of the at least one steered wheel. The at least one steered wheel may include two laterally-offset steered wheels, both of which are disposed forwardly of the powered wheel.

Alternatively, the steered device includes at least one ski and the drive system includes an engine operatively connected to an endless drive track. The at least one ski preferably includes two laterally-offset skis.

In yet another example, the steered device includes at least two steered wheels and at least one powered wheel. The drive system includes an engine operatively connected to the powered wheel. The powered wheel may be one of a plurality of rear wheels. The powered wheel may also be one of the steered wheels.

Additional and/or alternative aspects, features, and advantages of the present invention will become apparent from the following description, the accompanying drawings, and the appended claims.

### BRIEF DESCRIPTION OF THE DRAWINGS

For a better understanding of the present invention as well as other aspects and further features thereof, reference is made to the following description which is to be used in conjunction with the accompanying drawings, where:

FIG. 1 is a exploded perspective view of a conventional steering system;

FIG. 2 is a exploded perspective view of a steering system according to this invention, as viewed from the forward right side of the vehicle;

FIG. 3 is an enlarged top view of a swivel arm assembly thereof;

FIG. 4 is an enlarged perspective view of a safety bracket thereof;

FIG. 5 is a side view of a snowmobile embodying the steering system illustrated in FIGS. 2-4;

FIG. 6 is an enlarged top view of an alternative embodiment of a swivel arm assembly according to the present invention;

FIG. 7 is a top view of a three-wheel vehicle embodying an additional alternative embodiment of the steering assembly of the present invention;

FIG. 8 is a perspective view of the steering system thereof, as viewed from the forward right side of the vehicle;

FIG. 9 is a partial enlarged exploded perspective view of the swivel arm assembly thereof;

FIG. 10 is a partial perspective view thereof, as viewed from the forward right side of the vehicle;

FIG. 11 is a force/steering angle graph for a conventional fixed moment arm steering system and a steering system according to the present invention;

FIG. 12 is an angular position diagram of the steering actuator and steered device according to the present invention;

FIG. 13A is a cross-sectional view of the rear wheel assembly of the vehicle illustrated in FIG. 7;

FIG. 13B is a cross-sectional view of a rear wheel assembly according to yet a further alternative embodiment of the vehicle illustrated in FIG. 7;

FIG. 13C is a cross-sectional view of a rear wheel assembly according to yet a further alternative embodiment of the vehicle illustrated in FIG. 7; and

FIG. 14 is a perspective view of an ATV incorporating one of the embodiments of the steering assembly of the present invention.

### DETAILED DESCRIPTION OF PREFERRED EMBODIMENTS OF THE INVENTION

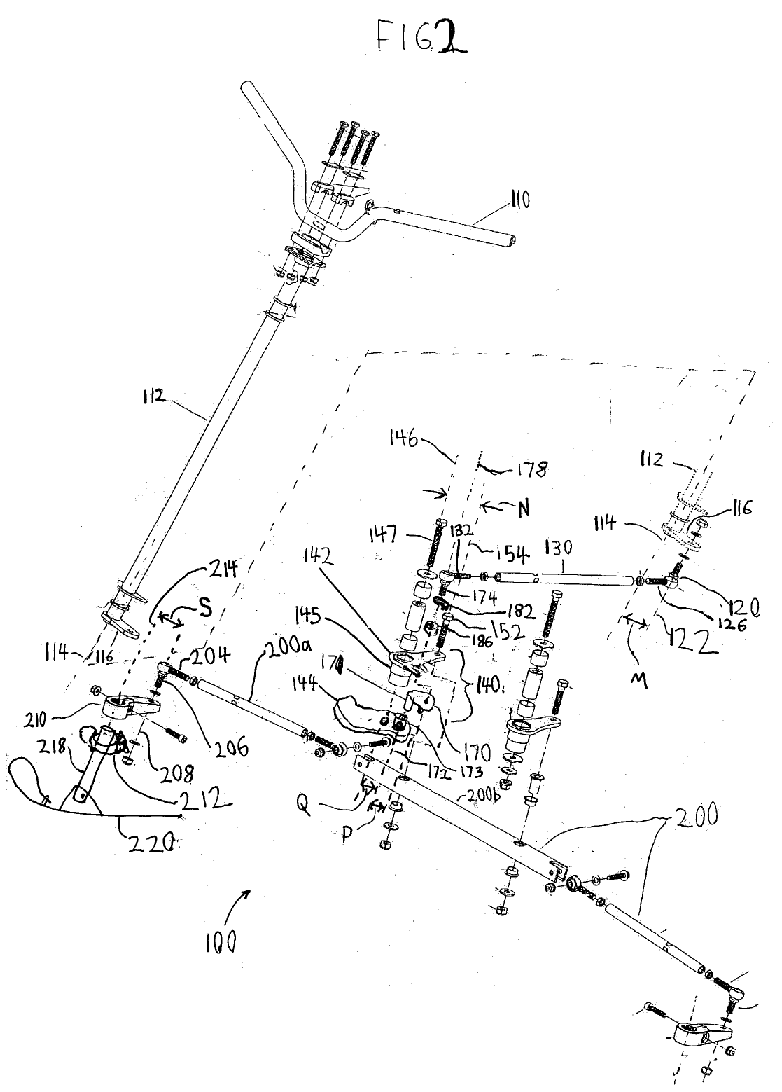

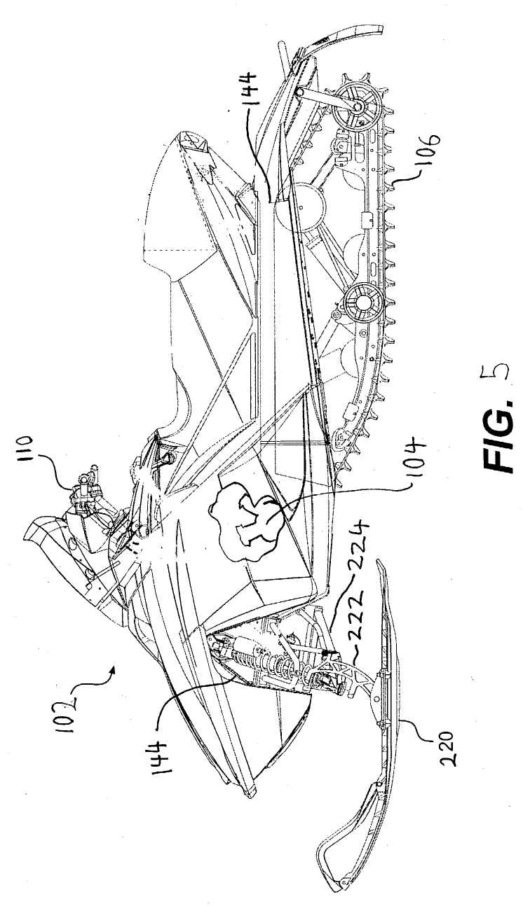

FIGS. 2-5 illustrate a progressive steering system 100 according to the present invention, as embodied in a snowmobile 102 seen in FIG. 5.

As shown in FIG. 5, the snowmobile 102 includes an engine (or other drive system) 104 supported by a frame 144 (see FIG. 5). An endless drive track 106 is supported by the frame 144 and operatively connected to the engine 104 to propel the snowmobile 102.

As illustrated in FIG. 2, a handlebar (or other steering actuator such as a steering yoke or wheel) 110 is connected to a steering shaft 112. The steering shaft 112 is mounted to the frame 144 of the snowmobile 102 for pivotal movement about a steering shaft axis 114 relative to the frame 144. A handlebar arm 116 extends radially outwardly from the steering shaft 112. A ball-end 120 defining an axis 122 is connected to the handlebar arm 116 such that the axis 122 is offset from the steering shaft axis 114 by a fixed distance M. A first handlebar tie rod eye-end 126, which is connected to one end/portion of a handlebar tie rod 130, is pivotally connected to the ball-end 120 such that the handlebar tie rod 130 pivots relative to the handlebar arm 116 about the axis 122. A second handlebar tie rod eye-end 132 is connected to the other end/portion of the handlebar tie rod 130.

As illustrated in FIGS. 2-4, a swivel arm assembly 140 includes a swivel arm 142 that is operatively mounted to the frame 144 (a portion of which is shown in FIG. 2) of the snowmobile 102 for pivotal movement relative to the frame 144 about a swivel arm axis 146. A cylinder 145 is attached to the swivel arm 142 and extends downwardly from the swivel arm 142 along the axis 146 to the frame 144 to vertically space the swivel arm 142 from the frame 144. A bolt 147, which extends along the axis 146, secures the swivel arm 142 to the frame 144 while allowing the swivel arm 142 to pivot relative to the frame 144.

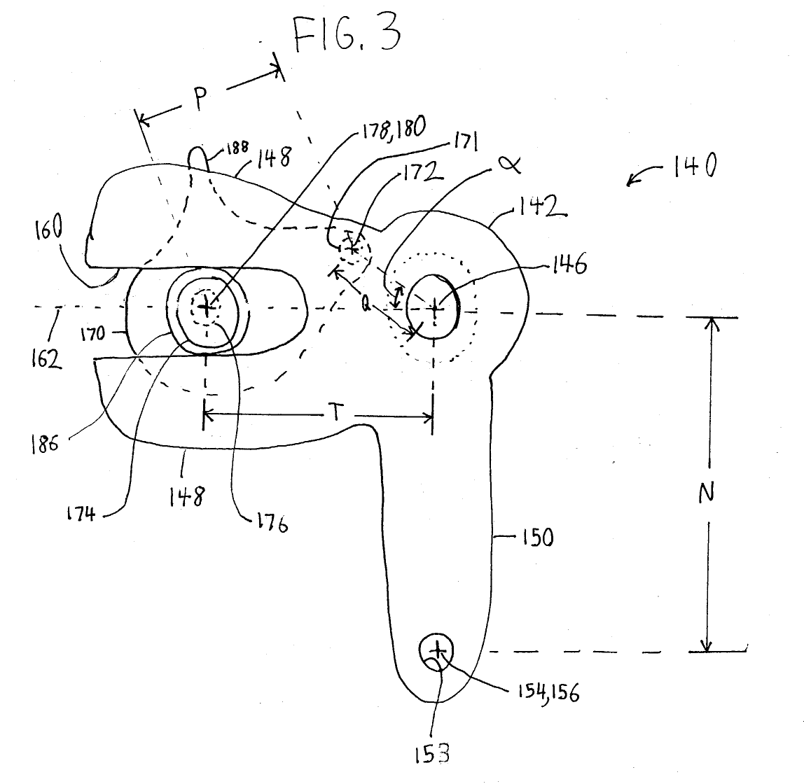

Referring to FIGS. 2 and 3, the swivel arm 142 includes first and second radially-extending arms 148, 150. A bolt 152 is fit into a hole 153 in the second arm 150. An axis 154 of the hole 153 and bolt 152 defines a force acting point 156 that is disposed a fixed distance N from the axis 146.

The first arm 148 includes therein a radially-extending groove 160 that extends linearly-outwardly from the axis 146 such that a line 162 defining a center of the groove 160 intersects the axis 146. Alternatively, the line 162 could be skewed such that it would not intersect the axis 146. Additionally, the groove 160 could define a shape other than a line such as an S-shape or an arc, depending on the steering requirements of the vehicle.

The swivel arm assembly 140 also includes a guide arm 170 that is operatively mounted to the frame 144 for pivotal movement relative to the frame 144 about a guide arm axis 172. The guide arm 170 includes a downwardly-extending pin 171 that fits within an upwardly-extending cylinder 173 on the frame 144 to provide for the pivotal connection between the guide arm 170 and the frame 144 and to space the guide arm 170 above the frame 144. While both the swivel and guide arms 142, 170 are spaced above the surface of the frame 144, the swivel arm 142 is disposed above the guide arm 170 to allow the arms 142, 170 to pivot without interfering with each other.

A ball-end 174 is threaded into a hole 176 in the guide arm 170. The ball-end 174 and hole 176 have an axis 178 that defines a second force acting point 180. The axis 178 and force acting point 180 are disposed a fixed distance P from the axis 172. The axis 172 is disposed on the frame 144 a fixed distance Q from the axis 146.

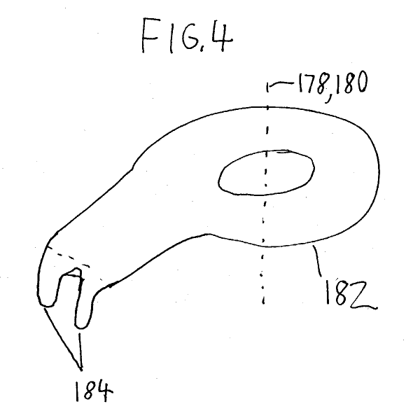

A ball bearing 186 is fit onto the ball-end 174 such that the ball bearing 186 is concentric with the ball-end 174, axis 178, and force acting point 180. An outer circumferential surface of the ball bearing 186 engages the inside walls of the groove 160 such that the ball-end 174, ball bearing 186, and force acting point 180 are constrained to motion that is relative to the swivel arm 142 along the groove 160 and line 162. A safety bracket 182 (see FIGS. 2 and 4) is clamped between the ball-end 174 and the ball bearing 186 above the swivel arm 142. The bracket 182 and guide arm 170 loosely sandwich the first arm 148 of the swivel arm 142 to ensure that the ball bearing 186 remains in the groove 160 and the guide arm 170 continuously engages the swivel arm 142. The bracket 182 preferably includes a forked end 184 that engages/surrounds a protrusion 188 in the guide arm 170.

The ball-end 174 is connected to the second handlebar tie rod eye-end 132 such that the handlebar tie rod 130 pivots relative to the guide arm 170 about the axis 178.

A laterally-extending steering arm tie rod 200 is connected by the bolt 152 to the second arm 150 of the swivel arm 142 for pivotal movement relative to the swivel arm 142 about an axis 154. The steering arm tie rod 200 is a preferably a compound rod having ball joints disposed therein that allows outer portions 200a (i.e., laterally outward portions) of the steering arm tie rod 200 to pivot relative to an inner portion 200b, which is pivotally connected to the swivel arm 142. The ball joints within the steering arm tie rod 200 enable the outer portions 200a to float up and down with the suspension of the snowmobile 102. The outer portion 200a is connected to a steering arm tie rod eye-end 204. The steering arm tie rod eye-end 204 is connected to a steering arm ball-end 206 having a center axis 208.

The steering arm ball-end 206 is connected to a steering arm 210 such that the outer portion of the steering arm tie rod 200a pivots relative to the steering arm 210 about the axis (or steering arm tie rod axis) 208. The steering arm 210 is operatively connected to a portion 212 of the frame 144 (preferably a suspension arm) for pivotal movement relative to the portion 212 about a steering arm axis 214 that is offset from the axis 208 by a predetermined distance S.

The axes 146, 154, 172, 178, 208, 214 are preferably generally parallel to each other. The steering arm 210 is connected to a shaft 218, which is, in turn, operatively connected to a ski (or steered device) 220. The ski 220, shaft 218, and steering arm 210 rotate in common about the axis 214 relative to the portion 212 of the frame 144 of the snowmobile 102. The axis 214 thereby acts as a steering axis (or steered device axis) 214 of the ski 220.

While only the left outer steering arm tie rod 200a, swivel arm 210, and ski 220 are described, a right side, which is a mirror-image of the left side, is also included in the steering system 100.

As illustrated in FIG. 5, the steering arm 210 and shaft 218 may be replaced by an integral steering arm 222. The steering arm 222 is pivotally supported by a suspension arm 224 that is pivotally connected to the frame 144 of the snowmobile 102.

To steer the snowmobile 102, a rider rotates the handlebar 110. The rotation of the handlebar 110 is transformed into semi-circular movement of the handlebar tie rod 130 via a moment arm formed over the distance M on the handlebar arm 116. The semi-circular movement of the handlebar tie rod 130 is reconverted into pivotal movement of the ball-end 174, force acting point 180, and guide arm 170 about the axis 172. As is described in greater detail below, this pivotal movement causes the swivel arm 142 to pivot about the axis 146. The pivotal movement of the swivel arm 142 is converted into semi-circular movement of the steering arm tie rod 200 via a moment arm formed over the distance N. The semi-circular movement of the steering arm tie rod 200 is again converted into pivotal movement of the steering arm 210 via a moment arm formed over the distance S on the steering arm 210. The ski 220 pivots with the steering arm 200 to steer the snowmobile 102.

Hereinafter, the functional relationships between the guide arm 170, swivel arm 142, and force acting points 156, 180 will be described with specific reference to FIG. 3. The force acting point 180, which is operatively connected to the handlebar 110, is spaced from the swivel arm axis 146 by the variable distance T. The force acting point 156, which is operatively connected to the ski 220, is spaced from the swivel arm axis 146 by the fixed distance N. Both force acting points 156, 180 pivot in common about the axis 146 on the swivel arm 142. Consequently, the relative lengths of the distances N and T on the swivel arm assembly 140 will determine (a) the degree to which the skis 220 pivot as the handlebar 110 is rotated and (b) the torque that a rider must exert on the handlebar 110 to rotate the skis 220. As the distance T decreases relative to the distance N, the required handlebar 110 pivoting torque increases, as does the rotational displacement of the skis 220 per degree of rotation of the handlebar 110.

As illustrated in FIG. 3, the distance T varies as a function of an angle α formed between the line 162 and a line formed between the axes 146, 172. As illustrated in FIG. 3, the swivel arm assembly 140 is steered to the left. Because both axes 146, 172 are fixed relative to the frame 144, the angle α defines an angle of the swivel arm 142 relative to the frame 144. When the skis 220 and handlebar 110 are in a neutral position (i.e., with the skis 220 facing straight ahead relative to the snowmobile 102), the angle α is preferably zero such that the axis 172 is disposed along the line 162 between the axes 146, 178. Consequently, the distance T is the largest when the skis 220 are in a neutral position. Thus, when the skis 220 are in the neutral position, the required handlebar 110 turning torque is minimized, as is the angle through which the skis 220 rotate per degree of rotation of the handlebar 110. A rider is therefore provided with the greatest amount of control over the steering angle of the skis 220 at and near the neutral angle, which is where the skis 220 face during a majority of snowmobiling activities.

As the handlebar 110 is pivoted away from the neutral position, the force acting point 180 pivots about the axis 172. The ball bearing 186 pivots with the force acting point 180 and engages the groove 160, thereby causing the swivel arm 142 to rotate about the axis 146. The rotation of the swivel arm 142 rotates the force acting point 156 and bolt 152, thereby rotating the skis 220.

Because the swivel arm assembly 140 forms a 3-bar slider mechanism between the line 162, the distance Q, and the distance P, the variable distance T decreases as the handlebar 110 is pivoted further away from the neutral position to the left or right. As the handlebar 110 is pivoted more (and the angle α increases), the required turning torque on the handlebar 110 increases as does the extent of rotation of the skis 220 per degree of rotation of the handlebar 110.

By varying the distance T, the swivel arm assembly 140 of this invention enables designers to improve/increase the steering range of the skis 220 without detrimentally increasing the amount of torque that a rider must apply to steer the snowmobile 102. Conversely, the swivel arm assembly 140 also decreases the torque that must be applied to the handlebar 110 to steer the skis 220 without decreasing the steering range of the snowmobile 102.

By having the distance T be larger near the neutral position (near an angle α of zero) than at the left and right extreme steering positions, the required torque is minimized at the low steering/angle α range that is used most often by snowmobile riders. Riders, therefore, have more control over the steering in the useful low angle α range. This improved steering control is achieved without sacrificing the steering range. While more torque must be applied to steer the skis 220 when the skis 220 are in the extreme turning positions, such extreme positions are still attainable.

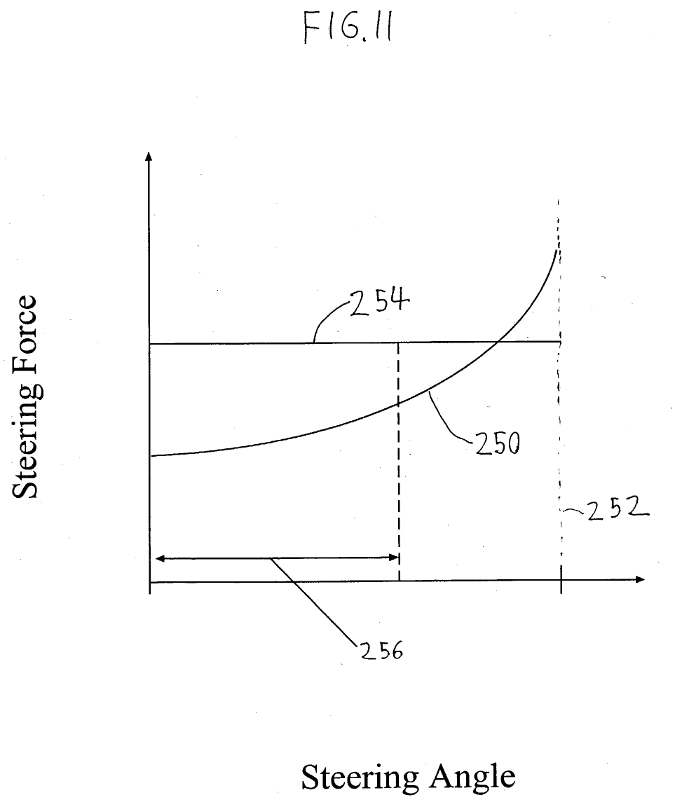

FIG. 11 illustrates a force/steering angle comparison between a conventional fixed moment arm steering system and a progressive steering system according to the present invention. The horizontal axis represents steering angle of the skis away from the neutral position (straight forward). The vertical axis represents the required steering force/torque that must be applied to the handlebar to turn the skis. The force curve 250 corresponds to a progressive steering system that has been designed to have the same extreme angle steering range 252 as the conventional steering system. The conventional steering system has a straight force curve 254. In the most commonly used lower angle steering range 256, the progressive steering system advantageously requires considerably less steering force/torque than the conventional steering system without sacrificing steering range to do so.

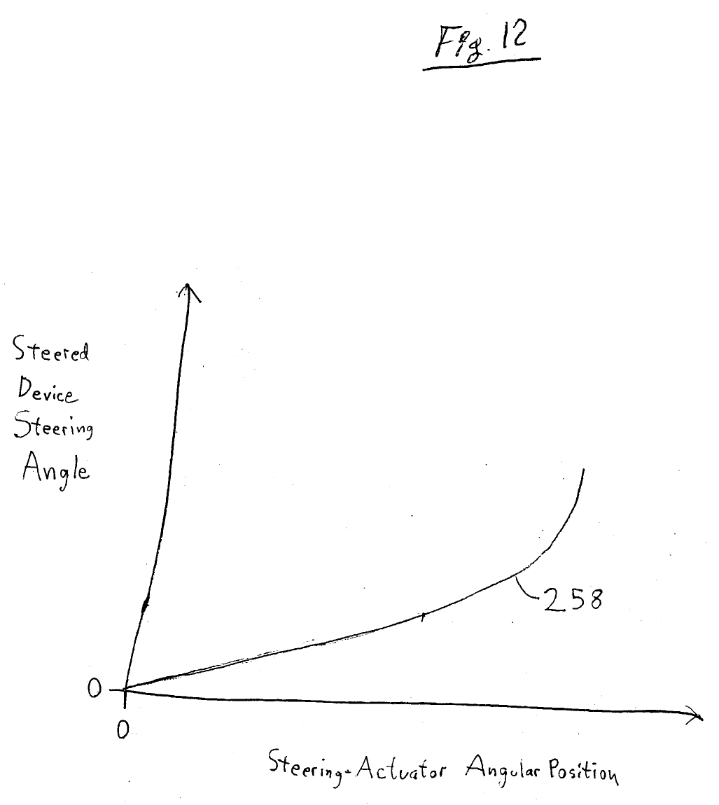

FIG. 12 illustrates the relative angular positions of the steering actuator (handlebar, steering wheel, etc.) and the steered device (skis, wheels, etc.) of a progressive steering system according to the present invention. The horizontal axis represents the angular displacement of the steering actuator about a steering actuator axis away from a steering actuator neutral position (i.e., an angular position of the steering actuator relative to the vehicle when the steered device is in a neutral position). The vertical axis represents the steering angle of the steered device away from the neutral steered device steering position. The slope of the curve 258 at any given point represents the instantaneous amount of steered device pivotal movement that will result from each degree of pivotal movement of the steering actuator. The instantaneous slope can also be thought of as a ratio of steering actuator pivotal movement per degree of steering actuator pivotal movement at the given steering actuator or steered device pivotal position. As illustrated, the slope of the curve 258 is relatively constant and shallow near the origin (i.e., at relatively small steering actuator and/or steered device steering angles). Consequently, the steered device will pivot a relatively small but relatively constant amount for each degree of rotation of the steering actuator when the steered device and steering actuator are near their neutral positions. As the steered device and steering actuator pivot further away from their neutral positions (i.e., the origin), the slope of the curve 258 gradually increases. Consequently, the steered device pivots about the steered device axis progressively more per degree of rotation of the steering actuator as the steering system is turned more and more to the left or right away from the neutral position. Near the extreme steering of the steered device and steering actuator angles (to the right and/or top of the curve 258), the slope is relatively large and the steered device pivots a relatively large amount for each degree of pivotal movement of the steered device.

As would be appreciated by one skilled in the art, the illustrated swivel arm assembly 140 is just one example of how a steering system 100 can be designed to include a variable-length moment arm that minimizes required handlebar torque at one position and maximizes steering rates at another position.

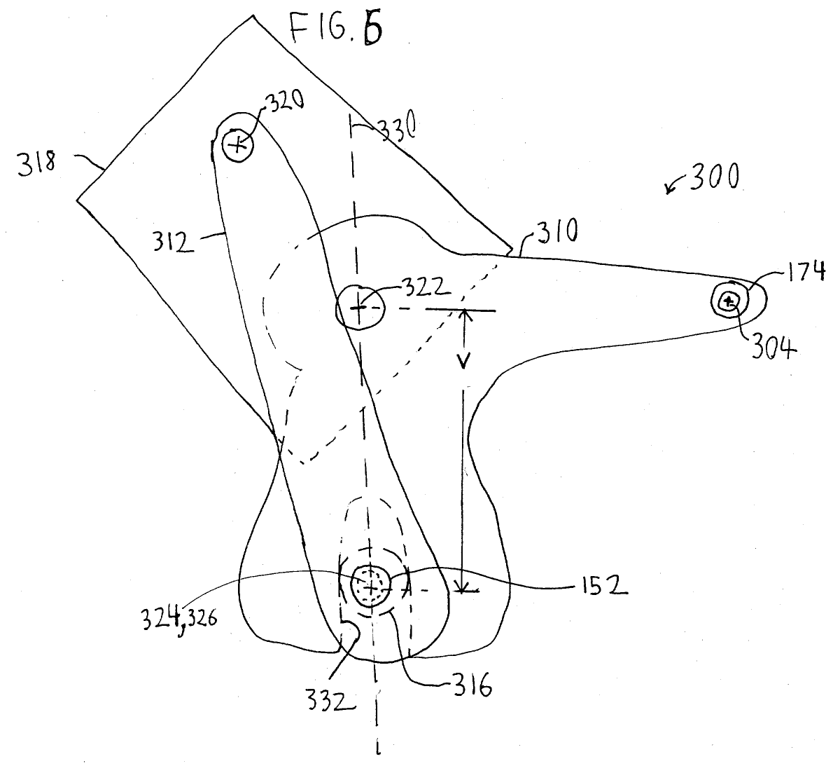

For example, FIG. 6 illustrates an alternative swivel arm assembly 300, which may be used in place of the swivel arm assembly 140 in the steering system 100. This embodiment differs from the previous embodiment in that the ball-end 174, which defines a force acting point 304 and is operatively controlled by the handlebar 110, is mounted onto the swivel arm 310, instead of the guide arm 312. Accordingly, the bolt 152 is mounted to the guide arm 312 and ball bearing 316, instead of the swivel arm 310. As in the previous embodiment, the guide arm 312 pivots relative to a portion 318 of the frame 144 about an axis 320. Similarly, the swivel arm 310 pivots relative to the portion 318 about an axis 322. The bolt 152 defines an axis 324 and force acting point 326. To accommodate pivotal connections between the arms 310, 312 and the portion 318 of the frame 144, the guide arm 312 is located above the swivel arm 310 (as opposed to the previous embodiment in which the guide arm 170 is disposed below the swivel arm 142).

In FIG. 6, the swivel arm assembly 300 is shown steering to the right. A line connecting the axes 320, 322 preferably extends along a longitudinal direction of the snowmobile 102. This arrangement is shifted ninety degrees as compared to the relative positions of the axes 146, 172 in the previous embodiment.

This embodiment further differs from the previous embodiment in that when the swivel arm assembly 300 is in a neutral position and the axes 320, 322, 324 are disposed on a line 330 formed by the groove 332, the axis 320 is disposed farther away from the axis 324 than the axis 322 is disposed away from the axis 324. Consequently, a variable distance V formed between the force acting point 326 and the axis 322 is the smallest when the swivel arm assembly 300 is in the neutral position. As the swivel arm 310 is pivoted away from the neutral position when the handlebar 110 moves the ball-end 174 and force acting point 304, the distance V increases. Consequently, while the force acting points 304, 326 are juxtaposed relative to the force acting points 156, 180 of the previous embodiment, a similar pivoting dynamic is developed between the handlebar 110 and the skis 220. In both embodiments, the turning torque is minimized near the neutral angle and the steering range is maximized at the extreme steering angles.

While in both of the above embodiments, the swivel arm assemblies 140, 300 comprise central pivoting assemblies disposed between handlebar tie rods and steering arm tie rods, this invention is not so limited. As would be appreciated by one of ordinary skill in the art, the swivel arm assembly of the present invention may replace any other moment arm disposed throughout a steering assembly. If the variable moment arm of the swivel arm assembly is on the handlebar/steering actuator/driving side of the steering system such that increasing the moment arm's length increases the steering range and the required handlebar torque, the length of the variable moment arm of the swivel arm assembly should increase as the moment arm is rotated away from the neutral position (as in the embodiment illustrated in FIG. 6). Conversely, if the variable moment arm of the swivel arm assembly is on the ski/steered device/driven side of the steering system such that decreasing the moment arm's length increases the steering range and the required handlebar torque, the length of the variable moment arm of the swivel arm assembly should decrease as the moment arm is rotated away from the neutral position (as in the embodiment illustrated in FIG. 3). Thus, a swivel arm assembly (i.e. swivel arm and guide arm) according to the present invention may comprise a handlebar arm or a steering arm with the variable moment arm disposed over the distances M and N, respectively (as illustrated in FIG. 2). Accordingly, the term swivel arm used herein applies generically to variable moment arm devices usable at various positions in the assembly.

In the above-illustrated embodiments, the variable-moment-arm steering systems are progressive steering systems. In a progressive steering system, the skis 220 are turned progressively more and more per degree of rotation of the handlebar 110 as the handlebar 110 and skis 220 are rotated away from the neutral position. In other words, the swivel arm assemblies 140, 300 are designed such that the turning torque and ski 220 rotation per degree of handlebar 110 rotation are minimized when the steering assembly 100 is in the neutral position. However, depending on the application, the lengths of the variable moment arms T, V could be maximized and/or minimized at other steering angles. For example, if a snowmobile 102 is to be raced primarily around a loop in a counterclockwise direction, the swivel arm assembly 140 of the first embodiment could be designed to maximize the length T when the skis 220 are angled to the left slightly. To accomplish this, the axis 172 would be positioned to the rear and to the side of the axis 146 (as opposed to the previous embodiment in which the axes 146, 172 were laterally-offset but disposed at the same longitudinal position along the snowmobile 102). Consequently, the angle α would be zero when the ski 220 is angled to the left slightly.

Alternatively, if it is desired to have greater steering power at the extreme steering angles of the skis 220, the swivel arm assembly 140 could be designed to maximize the moment arm T at the extreme left and right steering positions. Similarly, the swivel arm assembly 300 could be designed to minimize the moment arm V at the extreme left and right steering positions. For any application, the variable-moment-arm steering system of the present invention can be designed to optimize the steering characteristics at specified steering angles.

It is anticipated that the groove 160 in the swivel arm 142 may be shaped like an arc or S-shape to enable designers to create more complicated functions between the steering angle of the skis 220 and the moment arm length. Specific applications will dictate the desired function.

As described above, the goal of the invention is to vary a length of a moment arm within a steering system of a vehicle so as to vary the required turning torque and the ski's turning rate per degree of handlebar rotation as a function of the steering position of the ski. In the above illustrated embodiments, the moment arm length is varied using a 3-bar slider mechanism incorporating two offset pivoting arms. However, the present invention is intended to encompass any and all other types of devices that are known to one skilled in the art to be usable to vary a moment-arm length as a function of a steering position of a vehicle.

A variable moment arm steering system according to the present invention may also be utilized in vehicles other than snowmobiles. For example, such a system could be used in wheeled vehicles, including those with three or four wheels.

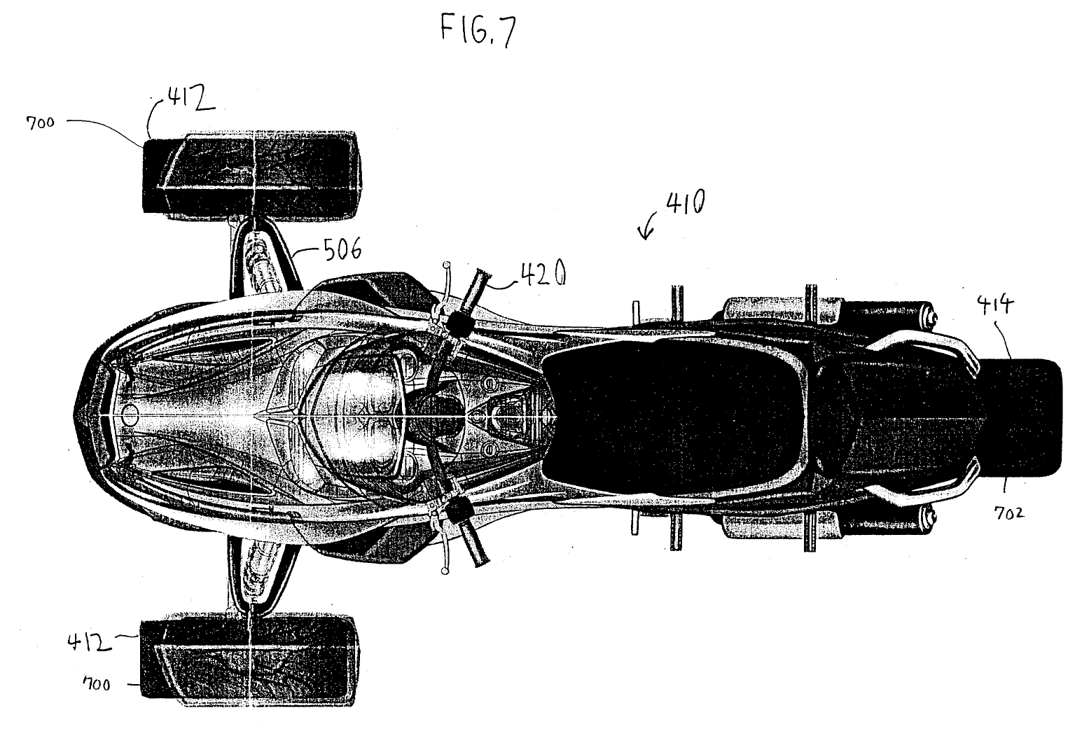

FIGS. 7-10 illustrate a progressive steering system 400 as embodied in a three-wheel vehicle 410. Because the vehicle 410 has two forward, laterally-offset steered wheels 412 and one powered rear wheel 414, the structure of the vehicle 410 and steering system 400 are quite similar to that of the snowmobile 102. Instead of powering an endless drive track 106, however, an engine of the vehicle 410 drives the rear wheel 414. The steering system 400 also differs from the steering systems 140, 300 of the snowmobile 102 because it is a direct steering system, which, as described below, eliminates the need for a handlebar tie rod.

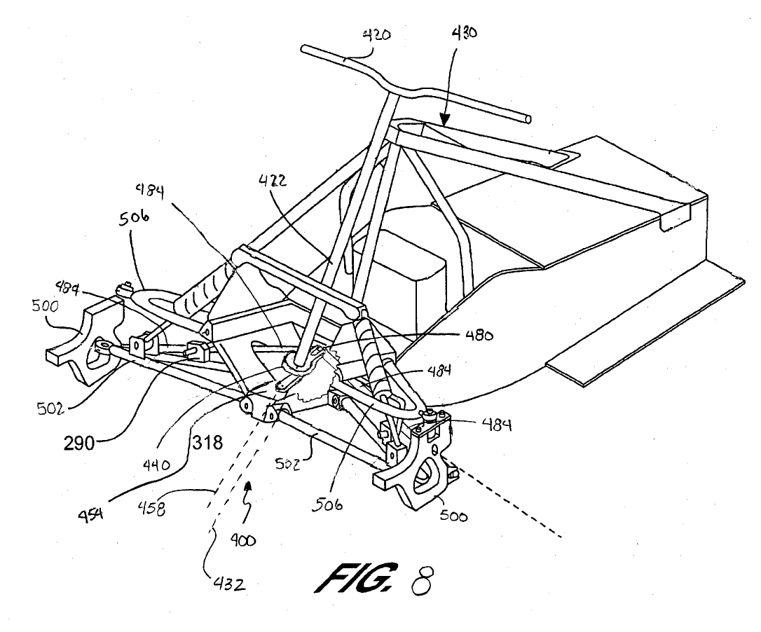

As illustrated in FIG. 8, the steering system 400 includes handlebar 420 attached to a handlebar shaft 422, which is mounted to a frame 430 of the vehicle 410 for pivotal movement relative to the frame 430 about a handlebar shaft axis 432.

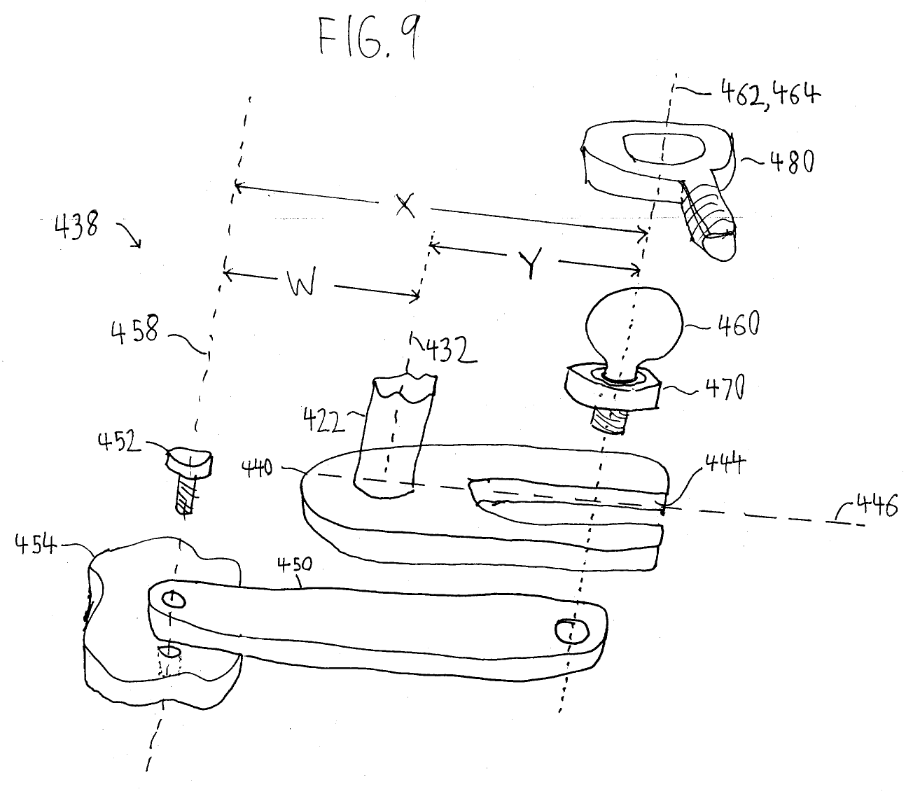

As illustrated in FIG. 9, a swivel arm assembly 438 includes a swivel arm 440 mounted to the handlebar shaft 422 for common rotation with the shaft 422 about the axis 432. A radially-extending groove 444 extends linearly outwardly from the axis 432 in the swivel arm 440. The groove 444 defines a centerline 446 that preferably intersects the axis 432. A guide arm 450 is mounted with a bolt 452 or other fastening device to a portion 454 of the frame 430 for pivotal movement relative to the frame portion 454 about a guide arm axis 458. The guide arm 450 is located below the swivel arm 440 such that neither arm 440, 450 interferes with the pivotal movement of the other arm 440, 450. The axes 432, 458 are offset from each other by a fixed distance W.

A ball-end 460 is mounted to the guide arm 450. The ball-end 460 defines an axis 462 and force acting point 464 that are offset from the guide arm axis 458 by a fixed distance X. A ball bearing 470 is fit onto the ball-end 460 and disposed at an axial position along the axis 462 corresponding to the groove 444. Consequently, the ball bearing 470 engages the inner surfaces of the groove 444 and the line 446 intersects the axis 462 and force acting point 464. The force acting point 464 is therefore spaced away from the swivel arm axis 432 by a variable distance Y. An eye-end 480 is connected to the ball-end 460 for relative rotation to the ball-end 460 about the axis 462.

While a fixed force acting point is not expressly defined by a particular axis on the swivel arm 440, the fixed force acting point can be any fixed point on the swivel arm 440 that is offset from the axis 432. Consequently, the fixed force acting point rotates in common with the shaft 422 and swivel arm 440 relative to the frame 430 about the axis 432.

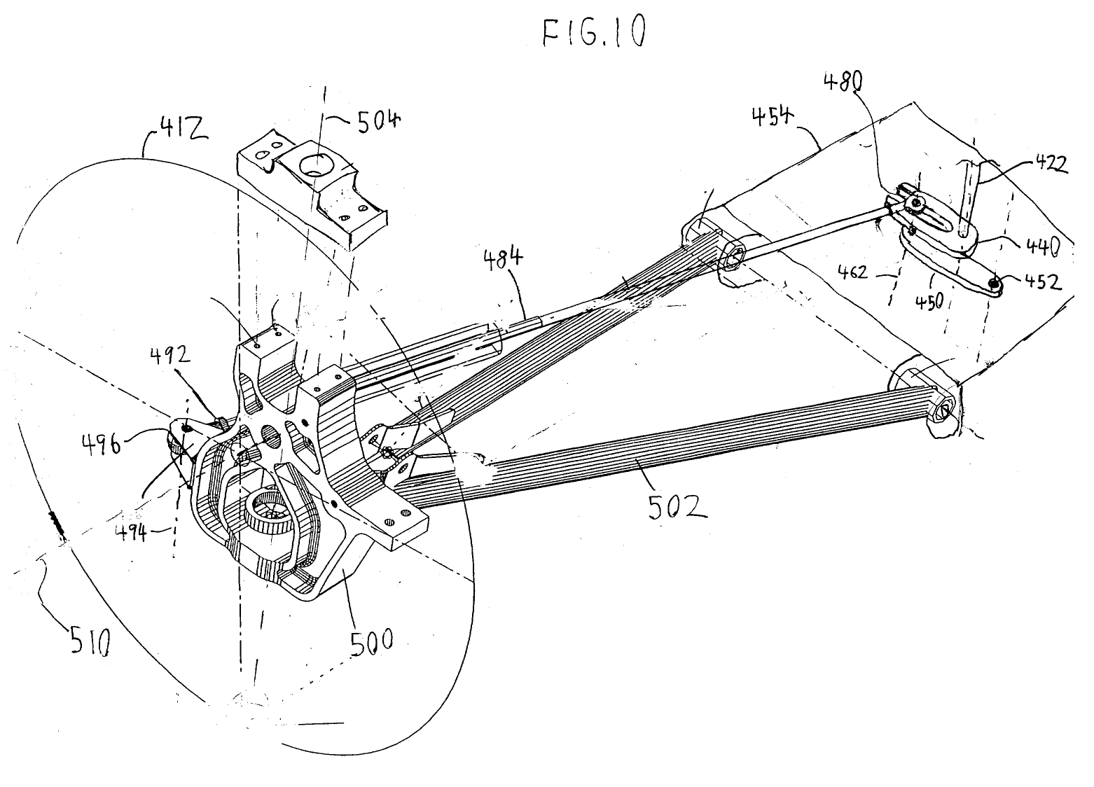

As illustrated in FIG. 10, the eye-end 480 is connected to a steering arm tie rod 484 such that the steering arm tie rod 484 pivots relative to the guide arm 450 about the axis 462. An outer end of the steering arm tie rod 484 is connected to an eye-end 492 having an eye-defined axis 494. The eye-end 492 is connected to a ball-end 496 that is attached to a steering arm 500. The steering arm 500 is pivotally connected to a suspension arm 502 for pivotal steering movement relative to the suspension arm 502 about a generally vertically extending axis 504. The axes 494, 504 are offset from each other by a fixed distance that defines a steering arm moment arm. The suspension arm 502 is operatively pivotally connected to the portion 454 of the frame 430 in a conventional manner. As illustrated in FIG. 8, an upper suspension arm 506 also operatively connects the frame 430 to the steering arm 500.

The wheel (or other steered device) 412 is rotationally connected to the steering arm 500 for rotation relative to the steering arm 500 about a wheel axis 510. The wheel 412 pivots in common with the steering arm about the steering arm axis (or steering axis or steered device axis) 504.

A left side of the steering system 400 of the vehicle 410 is generally a mirror image of the right side. A steering arm tie rod on the left side of the vehicle may be connected to the ball-end 460 in addition to the left side steering arm tie rod 484. Alternatively, a steering crosslink may extend between the left and right steering arms 500 such that the steering arms 500 pivot in common relative to the frame 430.

Operation of the steering system 400 is similar to the operation in the previous embodiments. As a rider pivots the handlebar 420, the shaft 422 and swivel arm 440 pivot about the axis 432. Engagement between the inner surfaces of the groove 444 and the ball bearing 470 forces the guide arm 450 to pivot about the axis 458. The ball-end 460 and force acting point 464 pivot with the guide arm 450, thereby axially moving the steering arm tie rod 484. Semicircular movement of the steering arm tie rod 484 is reconverted into pivotal steering movement of the steering arm 500 and attached wheel 412.

As in the embodiment illustrated in FIG. 6, the variable distance Y is minimized when the line 446 intersects the axes 432, 458. This minimization of the distance Y preferably occurs when the steering system 400 is in the neutral position. To accomplish this, the axes 432, 458 are longitudinally spaced relative to the frame 430, but laterally aligned relative to the frame 430. In other words, a line formed between the axes 432, 458 extends in a longitudinal direction of the vehicle 410. As the steering system 400 is turned to either the left or the right, the distance Y increases, thereby increasing (a) the pivotal steering movement of the wheels 412 per degree of handlebar 420 rotation, and (b) the torque that must be applied to the handlebar 420 to steer the wheels 412. Thus, the rider has greater control over the steered wheels 412 when the steering system 400 is near the neutral position and greater steering range when the steering system 400 is near its extreme turning positions.

Referring back to the overall vehicle 410 illustrated in FIG. 7, the wheels 412, 414 are all preferably 15 inch wheels but may be any other size as well. For example, one or more of the wheels 412, 414 may be 13 inch wheels. The wheels 412, 414 have tires 700, 702 disposed thereon that are suitable for road use. The tires 700, 702 may be automotive tires, for example.

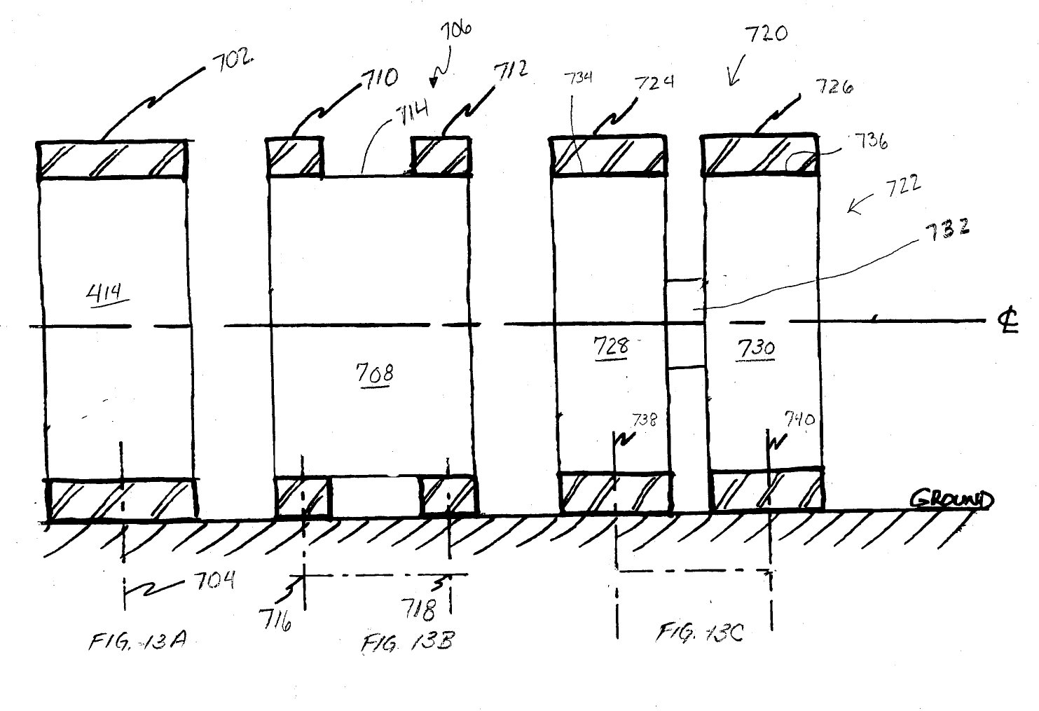

As illustrated in FIG. 13A, a centerline 704 of a patch (the footprint of a tire on the ground) of the tire 702 is located half way between the lateral sides of the tire 702. While the illustrated rear wheel 414 supports a single tire 702, the vehicle 410 may alternatively include more than one rear tire 702.

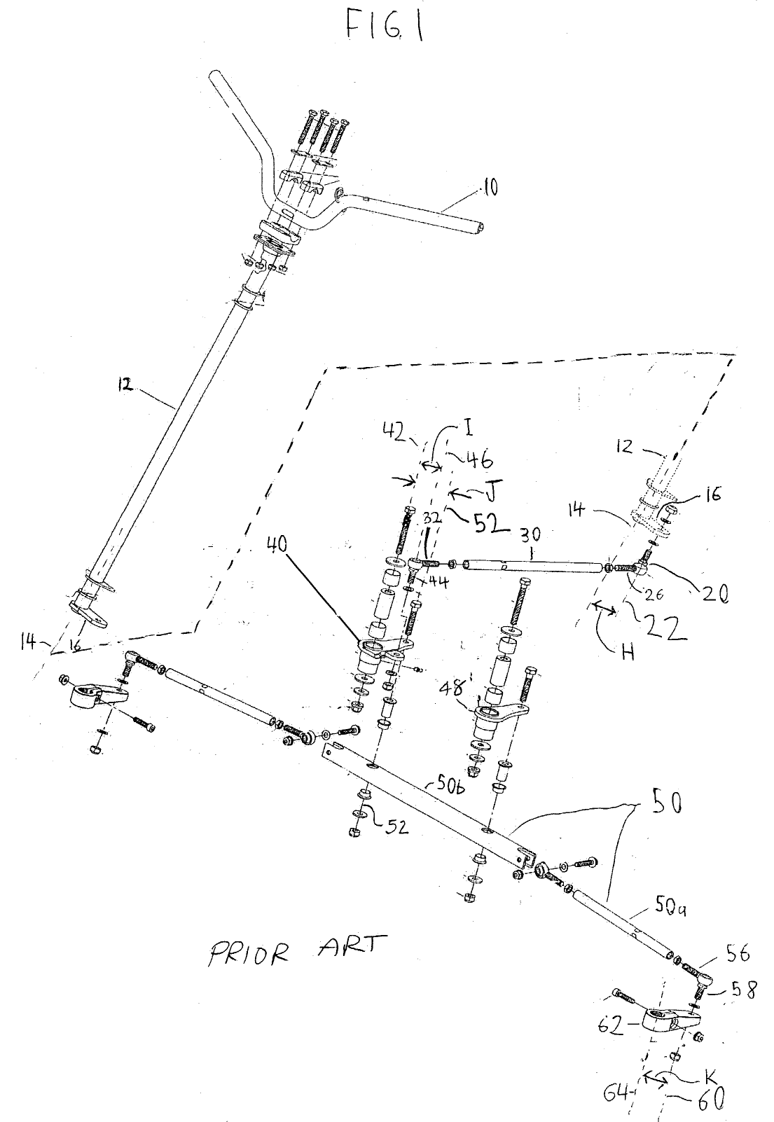

For example, FIG. 1 3B illustrates a rear wheel assembly 706 that may replace the rear wheel 414 and tire 702 illustrated in FIG. 7. The rear wheel assembly 706 includes a rear wheel 708 with two rear tires 710, 712. The tires 710, 712 are supported by a rim 714 of the wheel 708 and are preferably laterally separated from each other. However, the rear tires 710, 712 may alternatively touch or connect to each other. Tire patch centerlines 716, 718 of the rear tires 710, 712, respectively, are separated from each other by a lateral distance that is preferably less than or equal to 460 mm.

FIG. 13C illustrates an additional alternative rear wheel assembly 720, which may replace the rear wheel 414 and tire 702 illustrated in FIG. 7. The rear wheel assembly 720 includes a rear wheel 722 and two rear tires 724, 726. In this embodiment, the rear wheel 722 comprises two wheel subparts 728, 730 that are rigidly connected to each other via a central axle 732. The wheel subparts 728, 730 define distinct rims 734, 736, respectively. The wheel subparts 728, 730 and axle 732 may be integrally formed or may be mounted to each other after construction. The tires 724, 726 mount to the rims 734, 736, respectively, of the rear wheel 722. Tire patch centerlines 738, 740 of the rear tires 724, 726, respectively, are separated from each other by a lateral distance that is preferably less than or equal to 460 mm. While the illustrated rear wheel assemblies include either one or two rear tires, three or more rear tires may alternatively be mounted onto a rear wheel of the vehicle 410.

In the context of the present invention, a single rear wheel may support one or more distinct tires. As discussed above, the wheel may be built in one piece or be composed of many assembled parts. Regardless of how many parts the wheel includes or how many rear tires are used, the single rear wheel is designed such that the rear tires cannot rotate relative to each other about the wheel's axis.

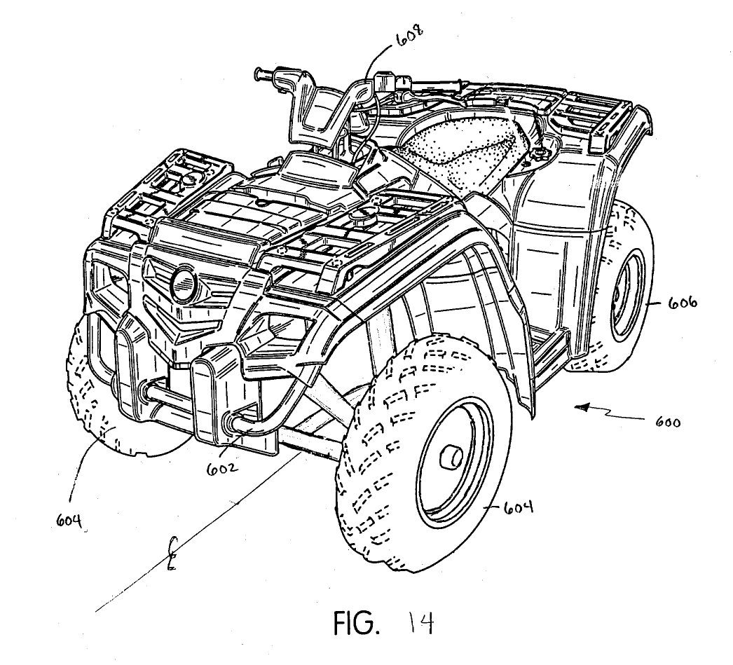

The present invention may also be applied to an ATV. One example of an ATV 600 is illustrated in FIG. 14. The ATV 600 shown is one of a variety of ATVs manufactured by Bombardier Inc. of Montreal, Quebec, Canada. The ATV 600 includes a frame 602. Two front wheels 604 and two rear wheels 606 are suspended from the frame 602. The ATV 600 includes a steering handlebar 608 that is operatively connected to the two front wheels 604. The rear wheels 606 are operatively connected to a power source, such as an internal combustion engine (not shown), which is disposed on the frame 602.

Like the three-wheeled vehicle 410 illustrated in FIG. 7, the ATV 600 includes a direct steering system. Accordingly, the ATV 600 is contemplated to include the steering system 400 discussed above.

While the illustrated steering systems are incorporated into a snowmobile, a three-wheel vehicle, or an ATV, on other types of vehicle as well. For example, the steering system may even be used to provide progressive steering to a rudder of a boat without deviating from the present invention.

As discussed above, the present invention may be applied to a variety of vehicles. Regardless of the vehicle type, however, the steering system will be operatively connected to some type of steered device. Steered devices include, but are not limited to, skis, wheels, and rudders.

The foregoing illustrated embodiments are provided to illustrate the structural and functional principles of the present invention and are not intended to be limiting. To the contrary, the principles of the present invention are intended to encompass any and all changes, alterations and/or substitutions within the spirit and scope of the following claims.

What is claimed is:

1. A vehicle comprising:
a frame;
a drive system supported by the frame;
a swivel arm connected to the frame for pivotal movement relative to the frame about a swivel arm axis;
a first force acting point disposed on the swivel arm a variable distance from the swivel arm axis;
a second force acting point disposed on the swivel arm a first predetermined fixed distance from the swivel arm axis;
a steered device supported by the frame for pivotal movement relative to the frame about a steered device axis, the steered device being operatively connected to one of the first and second force acting points; and
a steering actuator operatively connected to the other of the first and second force acting points, wherein the steering actuator selectively pivots the swivel arm between a neutral angle and an extreme angle relative to the frame to turn the vehicle,
wherein the variable distance varies as a function of an angle of the swivel arm relative to the frame about the swivel arm axis.

2. A vehicle according to claim 1, wherein:
the steered device is aligned with a forward direction of the vehicle when the swivel arm is disposed at the neutral angle relative to the frame,
wherein the steering actuator is operatively connected to the first force acting point, and
wherein the variable distance decreases as the swivel arm pivots away from the neutral angle toward the extreme angle.

3. A vehicle according to claim 1, wherein:
the steered device is aligned with a forward direction of the vehicle when the swivel arm is disposed at the neutral angle,
wherein the steered device is operatively connected to the first force acting point, and
wherein the variable distance increases as the swivel arm pivots away from the neutral angle toward the extreme angle.

4. A vehicle according to claim 3, wherein:
the steering actuator comprises a handlebar having a steering shaft, the steering shaft being connected to the swivel arm such that the swivel arm, the steering shaft, and the second force acting point pivot in common about the swivel arm axis relative to the frame.

5. A vehicle according to claim 1, wherein the first force acting point is constrained to movement that is relative to the swivel arm along a line.

6. A vehicle according to claim 5, wherein the line intersects the swivel arm axis.

7. A vehicle according to claim 5, further comprising:
a guide arm operatively connected to the frame for pivotal movement relative to the frame about a guide arm axis that is offset from the swivel arm axis, and
wherein the first force acting point is connected to the guide arm at a second predetermined fixed distance from the guide arm axis.

8. A vehicle according to claim 7, wherein the guide arm axis intersects the line when the steered device is aligned with a forward direction of the vehicle.

9. A vehicle according to claim 8, wherein a groove formed in the swivel arm defines the line.

10. A vehicle according to claim 9 wherein:
a ball-end is attached to the guide arm,
an axial centerline of the ball-end defines the first force acting point, and movement of the ball-end is constrained to movement that is along the line of the groove.

11. A vehicle according to claim 1, wherein the steering actuator comprises:
a handlebar pivotally connected to the frame for movement relative to the frame about a handlebar axis; and
a handlebar arm connected to the handlebar for common pivotal movement about the handlebar axis; and
wherein the vehicle further comprises a handlebar tie rod having first and second portions, the first portion of the handlebar tie rod being pivotally connected to the handlebar arm for pivotal movement relative to the handlebar arm about a handlebar arm axis that is offset from the handlebar axis, the second portion of the handlebar tie rod being pivotally connected to the swivel arm at the other of the first and second force acting points.

12. A vehicle according to claim 11, further comprising:
a steering arm connected to the steered device for common pivotal movement relative to the frame about the steered device axis;
a steering arm tie rod having first and second portions, the first portion of the steering arm tie rod being pivotally connected to the steering arm for pivotal movement relative to the steering arm about a first steering arm tie rod axis that is offset from the steering arm axis, the second portion of the steering arm tie rod being pivotally connected to the swivel arm at the one of the first and second force acting points.

13. A vehicle according to claim 1, wherein the steered device comprises at least one steered wheel and wherein the drive system comprises an engine operatively connected to a powered wheel.

14. A vehicle according to claim 13, wherein the powered wheel is disposed rearwardly of the at least one steered wheel.

15. A vehicle according to claim 14, wherein the at least one steered wheel comprises two laterally-offset steered wheels, both of which are disposed forwardly of the powered wheel.

16. A vehicle according to claim 13, wherein the vehicle has three wheels, including two steered wheels and one powered wheel.

17. A vehicle according to claim 1, wherein the steered device comprises at least one ski and wherein the drive system comprises an engine operatively connected to an endless drive track.

18. A vehicle according to claim 17, wherein the at least one ski comprises two laterally-offset steered skis.

19. A vehicle comprising:
a frame;
a drive system supported by the frame;
a steered device supported by the frame for pivotal movement relative to the frame about a steered device axis, the steered device having a neutral steering position in which the steered device aims straight forward relative to the frame;
a steering actuator supported by the frame for pivotal movement relative to the frame about a steering actuator axis;
a progressive steering system operatively connecting the steering actuator to the steered device, whereby the steered device pivots about the steered device axis progressively more and more per degree of rotation of the steering actuator as the steered device progresses pivotally away from the neutral steering position.

20. A vehicle according to claim 19, wherein the steered device has an extreme turning position in which the steered device is at its maximum steering angle, and
wherein a ratio of a pivotal steering movement of the steered device per degree of pivotal steering movement of the steering actuator is larger at when the steered device is near the extreme turning position than when the steered device is at the neutral position.

21. A vehicle according to claim 19, wherein the steering actuator is limited to pivotal movement about the steering actuator axis within a fixed pivotal range.

22. A vehicle according to claim 21, wherein the fixed pivotal range is less than 180 degrees.

23. A vehicle according to claim 22, wherein the fixed pivotal range is less than 50 degrees.

24. A vehicle according to claim 19, further comprising:
a seat disposed adjacent to the steering actuator,
wherein the seat is constructed and arranged to be straddled by a rider.
